(19) United States
(12) Patent Application Publication
(10) Pub. No.: US 2015/0169707 A1
(43) Pub. Date: Jun. 18, 2015

(54) REPRESENTATIVE SAMPLING OF RELATIONAL DATA

(71) Applicants: University College Dublin, Dublin (IE); International Business Machines Corporation, Armonk, NY (US)

(72) Inventors: Teodora S. Buda, Dublin (IE); Morten K. Kristiansen, Navan (IE); Nirmala Venkatraman, Westford, MA (US)

(73) Assignees: University College Dublin, Dublin (IE); International Business Machines Corporation, Armonk, NY (US)

(21) Appl. No.: 14/132,058

(22) Filed: Dec. 18, 2013

(51) Int. Cl. G06F 17/30

(52) U.S. Cl. CPC G06F 17/30554

(57) ABSTRACT

A computing device determines a first table included in a plurality of tables, wherein the plurality of tables are included in the database. The computing device determines a dependency corresponding to the first table, wherein the dependency identifies a second table that is included in the plurality of tables. The computing device determines a distribution corresponding to the dependency, wherein the distribution identifies a correlation corresponding to the first table and to the second table. The computing device analyzes the correlation to determine a group of data values of the first table and the second table. The computing device selects a subset of data values from the group of data values. The computing device populates a sample with the subset.

### BACKGROUND OF THE INVENTION

The present invention relates generally to the field of relational databases, and more specifically to representative sampling of relational databases.

Data sampling is the process of selecting a subset of data from a statistical population of data to estimate characteristics of the whole population. A sample is representative of a population if the sample approximates the characteristics of the population. Sampling enables testing of a subset of data (i.e., the sample) to predict the results of a test on a larger set of data (i.e., the population). The more representative a sample is of a particular population, the more accurate such a prediction is.

Relational databases have a collection of tables of data values, wherein tables are related to other tables through relational constraints, which are dictated by a foreign key in one table of the relational database that matches a primary key in another table. Relational constraints, by the foreign keys and primary keys, establish and enforce a link between the data in two tables.

### SUMMARY

A computing device determines a first table included in a plurality of tables, wherein the plurality of tables are included in the database. The computing device determines a dependency corresponding to the first table, wherein the dependency identifies a second table that is included in the plurality of tables. The computing device determines a distribution corresponding to the dependency, wherein the distribution identifies a correlation corresponding to the first table and to the second table. The computing device analyzes the correlation to determine a group of data values of the first table and the second table. The computing device selects a subset of data values from the group of data values. The computing device populates a sample with the subset.

### BRIEF DESCRIPTION OF THE SEVERAL VIEWS OF THE DRAWINGS

FIG. 1 is a functional block diagram illustrating an environment, in accordance with an embodiment of the present invention.

FIG. 2 depicts an illustrative example of a relational database, in accordance with an embodiment of the present invention.

FIG. 3 is a flowchart depicting operational steps of a sampling program, for representative sampling of a relational database, in accordance with an embodiment of the present invention.

FIG. 4 depicts a block diagram of components of a computer system, in accordance with an embodiment of the present invention.

### DETAILED DESCRIPTION

Embodiments of the present invention recognize that using operational data is useful for performance evaluation of software, but managing large amounts of data can be computationally costly, for example when processing power requirements scale with the amount of data. Further recognized is that performance evaluation using a subset of the operational data has a lower computational cost, but an arbitrarily-selected subset may yield inaccurate testing results, especially if the subset is a non-representative sample of the operational data. Such operational data may be a database, such as a relational database.

Embodiments of the present invention provide for representative sampling of a database of relational data. Embodiments of the present invention recognize that a sample can be more representative if it accounts for relational constraints among the data of the database sampled. Embodiments of the present invention provide a method for representative sampling of a relational database while maintaining the relational constraints of the data. Implementation of such embodiments may take a variety of forms, and illustrative implementation details are discussed subsequently with reference to the Figures.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, or semiconductor system, apparatus, or device, or any suitable combination of the foregoing. More specific examples (a non-exhaustive list) of a computer-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device. The term “computer-readable storage media” does not include computer-readable signal media.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java® (Java is a registered trademark of Oracle in the United States, other countries, or both), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

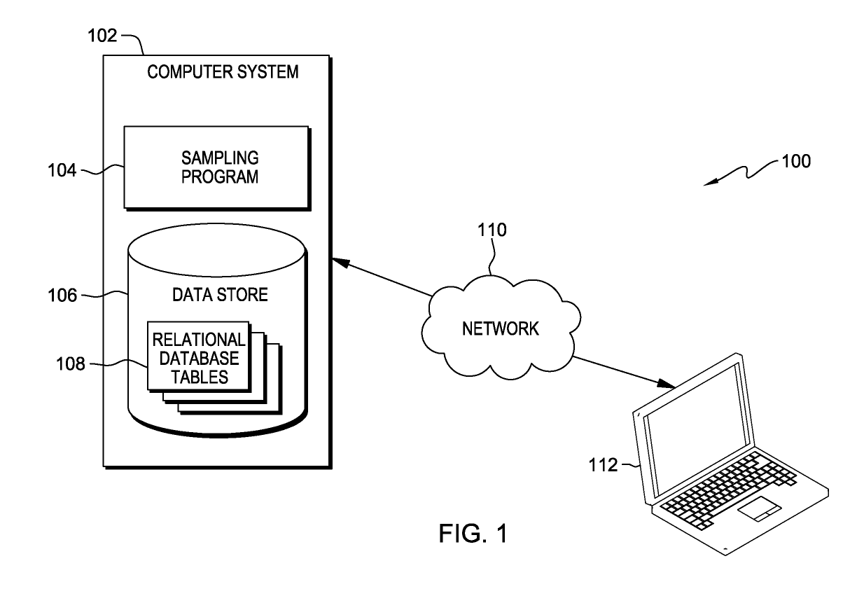

The present invention will now be described in detail with reference to the Figures. FIG. 1 is a functional block diagram illustrating an environment, generally designated 100, in accordance with an embodiment of the present invention.

Environment 100 includes computer system 102 and client device 112, both interconnected over network 110.

Network 110 can be, for example, a local area network (LAN), a wide area network (WAN) such as the Internet, or a combination of the two, and can include wired, wireless, or fiber optic connections. In general, network 110 can be any combination of connections and protocols that will support communications between computer system 102 and client device 112.

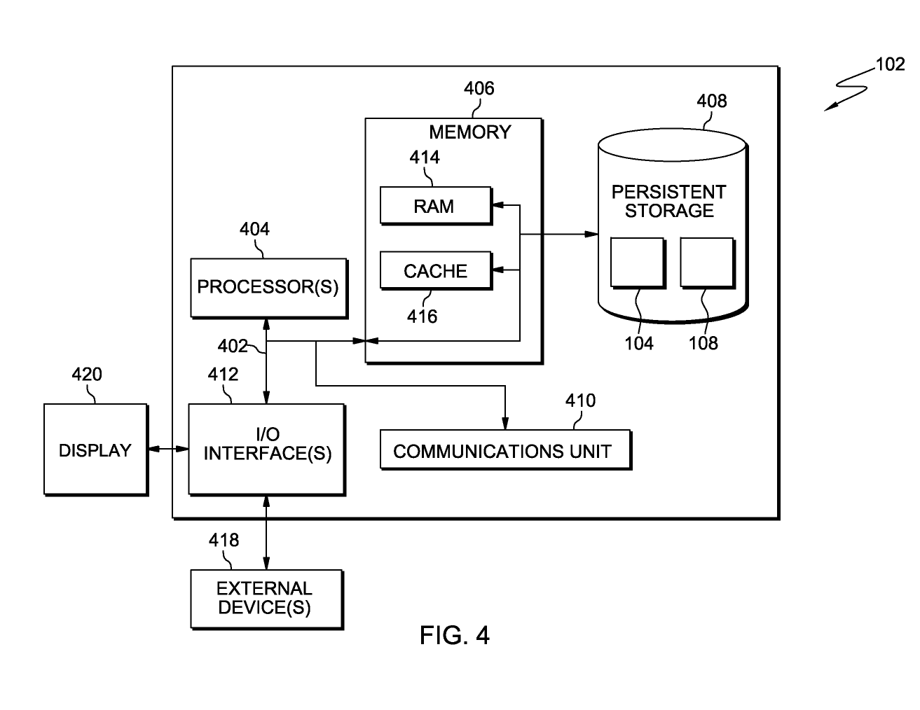

In various embodiments of the present invention, computer system 102 and client device 112 may each respectively be a laptop computer, a tablet computer, a netbook computer, a personal computer (PC), a desktop computer, a personal digital assistant (PDA), a smart phone, or any programmable electronic device capable of communicating with client device 112 or computer system 102, respectively, via network 110. Computer system 102 may send and/or receive information to/from client device 112, and vice versa. Client device 112 may include an application capable of facilitating communication with computer system 102 (e.g., a network file browser or a web browser). In the depicted embodiment, computer system 102 includes sampling program 104, data store 106, and relational database tables (“RDT”) 108. Computer system 102 may include internal and external hardware components, as depicted and described in further detail with respect to FIG. 4.

Data store 106 is an information repository that includes RDT 108. RDT 108 comprises relational data, such as relational tables, and will be described in more detail below. Data store 106 may be written and read by sampling program 104. In one embodiment, sampling program 104 may write one or more relational tables to data store 106. In one embodiment, sampling program 104 may receive one or more relational tables as user input (from, for example, client device 112). In one embodiment, data store 106 is included in computer system 102. In other embodiments, data store 106 resides on another computer device that is in communication with network 110. In some embodiments, data store 106 is included in an independent computer system utilizing clustered computers and components that act as a single pool of seamless resources when accessed through network 110, as is common in data centers and with cloud computing applications.

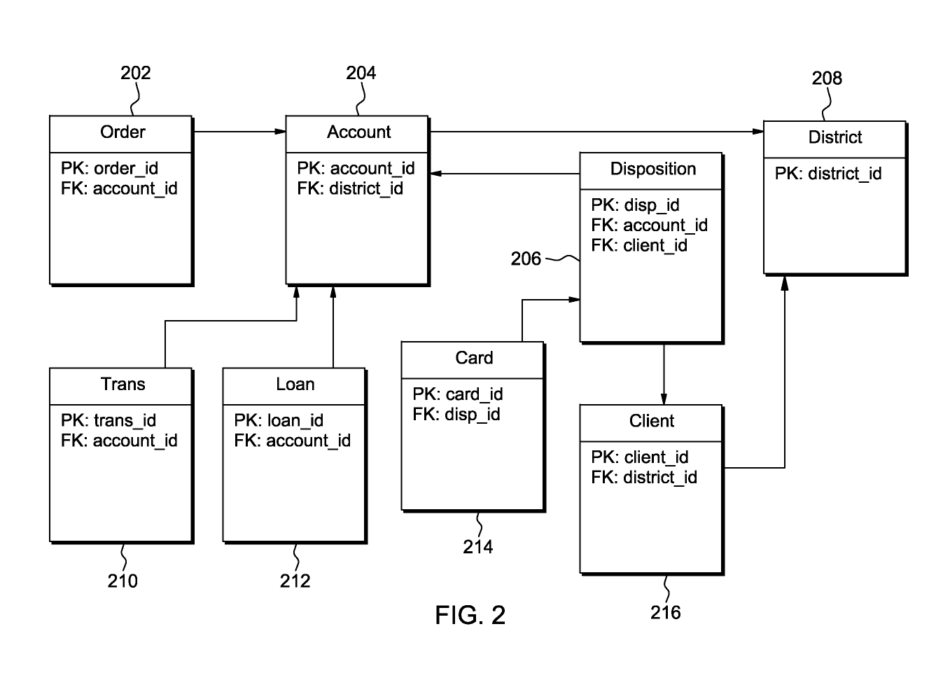

RDT 108 may comprise a plurality of tables, each of which may include one or more primary keys, foreign keys, and/or data values. An illustrative example of an embodiment of RDT 108 is discussed in more detail in connection with FIG. 2 (discussed below). Tables included in RDT 108 are referentially related to at least one other table therein by primary keys and foreign keys that are associated with the tables. A primary key identifies a data value which is a member of a record. A record is a collection of related data values, each residing in a table of RDT 108. A foreign key of a first table references a primary key of a second table. A first table directly references a second table (and the second table is directly referenced by the first table) when a foreign key of the first table references a primary key of the second table. References may also be indirect, meaning that one or more other tables link the referencing table and the referenced table by a series of direct references.

A “leaf” is a table that does not reference any other table of the database but is referenced by at least one other table of the database. An “orphan” is a table that neither references nor is referenced by any other table of the database. In an embodiment, the database comprises zero orphan tables, in which case every table of the database references, directly or indirectly, every other table of the database, which is a condition which may be referred to as being “fully connected.” As discussed below, in the depicted embodiment of FIG. 2, RDT 108 is an example of a fully connected database.

Sampling program 104 resides on computer system 102 and operates to determine a representative sample of a relational database. The relational database comprises relational data, such as relational tables. In one embodiment, the sample is a subset of the relational database. In one embodiment, the sample comprises a plurality of relational tables.

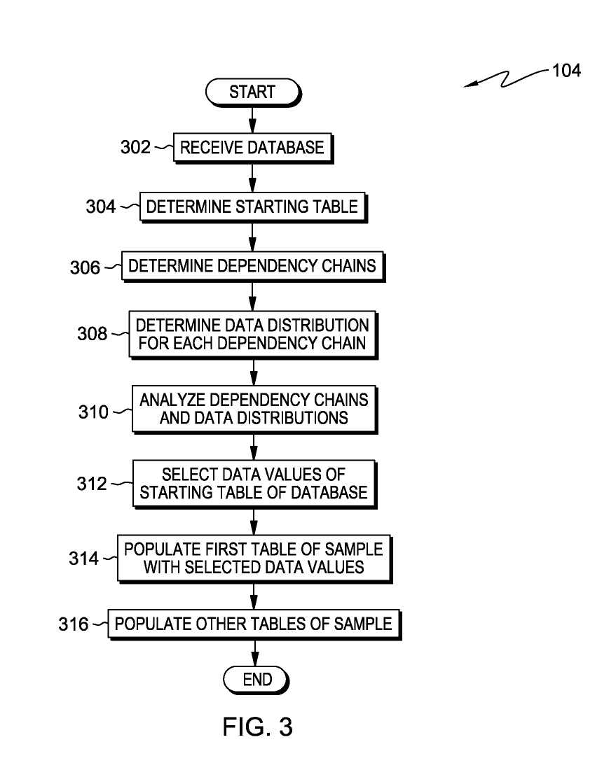

Sampling program 104 generates dependency chains from the tables of RDT 108. Sampling program 104 determines dependency chains by following foreign key and primary key relationships of the relational database, starting with a starting table. The starting table comprises a plurality of data values, each of which comprises at least one primary key and/or at least one foreign key. In one embodiment, sampling program 104 can identify a foreign key of the starting table, the foreign key identifying a primary key of a second table. A dependency chain is a sequence of tables in which each table of the sequence is linked to another table of the sequence either directly or indirectly through a referential relationship, meaning a reference of a foreign key in one table to a primary key in another table. A dependency chain may be “top-down” or “bottom-up.” A top-down dependency chain is one in which the first table of the chain directly or indirectly references each subsequent table of the chain. A bottom-up dependency chain is one in which the first table of the chain directly or indirectly is referenced by each subsequent table of the chain. Sampling program 104 is discussed in greater detail in connection with FIGS. 2-3.

Sampling program 104 analyzes the data distribution of the dependency chains. A data distribution comprises at least one correlation, which comprises a quantity of data values of a first table and a quantity of data values of a second table, wherein data values of the first and second tables are related through a relational constraint. Each correlation comprises an x-value and a y-value. Each x-value and y-value identifies a quantity of data values of a table to which the x-value or y-value corresponds. Sampling program 104 generates a sample database with a data distribution which is representative of at least one table of RDT 108 while preserving the relational constraints of RDT 108. Data distributions are discussed in more detail in connection with FIGS. 2 and 3.

Sampling program 104 determines each dependency chain starting with a starting table. In an embodiment, the starting table is the leaf comprising the greatest number of records. Alternatively, the starting table may be identified by user input. In various alternate embodiments, the starting table may be the table containing the largest amount of data, the table with the most primary and/or foreign keys, a random table, or the table most relevant (e.g., as determined by a user) to the desired sample.

In an embodiment, the starting table is a leaf and the dependency chain is a bottom-up dependency chain (i.e., the starting table is directly or indirectly referenced by each subsequent table of the dependency chain). In such an embodiment, sampling program 104 identifies a primary key of the starting table and determines a secondary key comprising a foreign key, in which case the starting table is directly referenced by the second table and the resulting dependency chain includes the starting table and the second table.

FIG. 2 depicts an example implementation of RDT 108, in accordance with an illustrative embodiment of the present invention. The illustrative example of FIG. 2 is provided to facilitate discussion of aspects of the present invention, and it should be appreciated that FIG. 2 provides only an illustration of an embodiment of the present invention and does not imply any limitations with regard to the variations or configurations in which different embodiments may be implemented.

One dependency chain may include some or all of the tables included in another dependency chain. For example, if a first table is referenced by a second table and the second table is referenced by a third table, then the dependency chains may include <first table, second table> and <first table, second table, third table> (assuming that the first table is the starting table). In this example, the second dependency chain includes all of the tables included in the first dependency chain, but the last table of the first and second dependency chains are different. Thus, <district table 208, account table 204> and <district table 208, account table 204, order table 202> are both valid dependency chains for the illustrative example database depicted in FIG. 2.

Depending on the relationships between the tables of a database, multiple dependency chains may have the same first and last table. Thus, it is possible for one table to be indirectly referenced by another table through multiple dependency chains. For example, a first dependency chain may be <district table 208, account table 204, disposition table 206> and a second dependency chain may be <district table 208, client table 216, disposition table 206>. In this case, the first and second dependency chains are of equal length. Also, the first and second dependency chains have the same starting and ending tables. The length of a dependency chain indicates the number of tables in the dependency chain. In an embodiment, sample program 104 retains multiple dependency chains with the same starting and ending tables if each of the multiple dependency chains are of equal length. In an embodiment, sampling program 104 discards a longer dependency chain of two dependency chains with the same starting and ending tables.

In a bottom-up dependency chain, each table in the dependency chain is directly referenced by the immediately subsequent table of the dependency chain. Except, however, for the last table in a bottom-up dependency chain, which is not referenced by another table. Thus, in a bottom-up dependency chain, the first table is referenced by the last table directly (if the chain is two tables long) or indirectly (if the chain is three or more tables long). For example, in the bottom-up dependency chain <district table 208, account table 204, disposition table 206>, the first table (district table 208) is referenced indirectly by the last table (disposition table 206).

Similarly, in a top-down dependency chain, each table in the dependency chain directly references the immediately subsequent table of the dependency chain. Except, however, for the last table in a top-down dependency chain, which does not reference another table of the dependency chain. Thus, in a top-down dependency chain, the first table references the last table directly (if the chain is two tables long) or indirectly (if the chain is three or more tables long). For example, in the top-down dependency chain <card table 214, disposition table 206, client table 216>, the first table (card table 214) indirectly references the last table (client table 216).

In the illustrative example depicted in FIG. 2, sampling program 104 may determine dependency chains using district table 208 as a starting table. District table 208 is a leaf. Thus, sampling program 104 determines bottom-up dependency chains with district table 208 as the first table. Sampling program 104 determines the following dependency chains by following the referential relationships of the database: <district table 208, client table 216>, <district table 208, client table 216, disposition table 206>, <district table 208, client table 216, disposition table 206, card table 214>, <district table 208, account table 204>, <district table 208, account table 204, disposition table 206>, <district table 208, account table 204, disposition table 206, card table 214>, <district table 208, account table 204, order table 202>, <district table 208, account table 204, trans table 210>, <district table 208, account table 204, loan table 212>.

In some embodiments, the starting table may be a table which is not a leaf. In such embodiments, the first table of the dependency chain may be a table other than the starting table. For example, using account table 204 as a starting table, a dependency chain may be: <account table 204, disposition table 206, card table 214>.

FIG. 3 is a flowchart depicting operational steps of sampling program 104 for representative sampling of a relational database, in accordance with an embodiment of the present invention.

In step 302, sampling program 104 receives a database from which sampling program 104 generates a representative sample. In one embodiment, sampling program 104 may utilize the tables of RDT 108. In an alternative embodiment, sampling program 104 may receive the contents of a database as input, for example as input from client device 112, in which case sampling program 104 may write the received information to data store 106.

In step 304, sampling program 104 determines a starting table of the received database. In an embodiment, sampling program 104 receives user input from client device 112 indicating a table of RDT 108 as the starting table. For example, sampling program 104 may receive user input indicating a leaf of RDT 108 as the starting table.

In step 306, sampling program 104 determines the dependency chains of RDT 108. In an embodiment, sampling program 104 determines bottom-up dependency chains starting with the starting table. In another embodiment, the starting table is a leaf. In another embodiment, the starting table is not a leaf. In another embodiment, sampling program 104 determines top-down dependency chains. Determination of dependency chains is discussed in further detail in connection with FIG. 2.

In step 308, sampling program 104 determines data distributions for each dependency chain. As previously stated, each dependency chain corresponds to a first table and a last table and, in one embodiment, the first table is the starting table. Sampling program 104, for each dependency chain, determines a data distribution, which comprises at least one correlation. Each correlation comprises an x-value and a y-value. Each x-value and y-value identifies a quantity of data values of a table to which the x-value or y-value corresponds. In an embodiment, sampling program 104 determines the x-value and y-value by correlating data values of the first table and last table and counting the number of data values of each table which correlate to data values of the other table.

In one embodiment, for a data distribution of a bottom-up dependency chain, the x-value identifies a quantity of data values of the first table which are referenced by (directly or indirectly) a quantity of values of the last table, which are identified by the y-value. For example, in the bottom-up dependency chain <district table 208, account table 204, disposition table 206>, if seven data values of district table 208 are indirectly referenced by fifty-four data values of disposition table 206, then the data distribution of the dependency chain includes a correlation with an x-value of seven and a y-value of fifty-four. In this case, the x-value of the correlation corresponds to seven data values of district table 208 and the y-value of the correlation corresponds to fifty-four data values of disposition table 206.

In another embodiment, for a data distribution of a top-down dependency chain, the y-value identifies a quantity of data values of the first table which reference (directly or indirectly) a quantity of values of the last table, which are identified by the x-value. For example, in the top-down dependency chain <disposition table 206, account table 204, district table 208>, if seven data values of disposition table 206 indirectly reference fifty-four data values of district table 208, then the data distribution of the dependency chain includes a correlation with an x-value of fifty-four and a y-value of seven. In this case, the x-value of the correlation corresponds to fifty-four data values of district table 208 and the y-value of the correlation corresponds to seven data values of disposition table 206.

In some embodiments, sampling program 104 operates to present the data distribution of a dependency chain in a graphical format. For example, sampling program 104 may plot the correlations of a data distribution on a graph, such as a scatter plot. In such an example, sampling program 104 plots each correlation on the scatter plot according to the x-value and y-value of the correlation at graph coordinates (x-value, y-value). In one embodiment, for a top-down dependency chain, the x-axis of the scatter plot corresponds to the last table and the y-axis corresponds to the first table. In another embodiment, for a bottom-up dependency chain, the x-axis of the scatter plot corresponds to the first table and the y-axis corresponds to the last table.

In step 310, sampling program 104 analyzes each dependency chain and the corresponding data distribution to group data values of the starting table of the database. A group of data values includes one or more data values of the starting table which correspond to the same correlations for each data distribution. For example, sampling program 104 compares a first data value and a second data value of the starting table to determine if the first and second data values correspond to the same correlation in the data distribution for each table of the database. Sampling program 104 groups the first and second data values if they correspond to the same correlation in each data distribution.

In some embodiments, sampling program 104 may receive an importance value corresponding to one or more of tables, which may indicate whether a table is of high importance or low importance. In an alternate embodiment, the importance value indicates whether a corresponding table is important. When grouping data values of the starting table, sampling program 104 compares only the data distributions of tables which are of high importance (or, alternatively, only the data distributions of those tables which are not of low importance).

In step 312, sampling program 104 selects data values of the starting table of the database. In an embodiment, sampling program 104 selects data values of the sampling rate in a proportion indicated by a sampling rate, which may be predetermined. The sampling rate may, in one embodiment, be received as user input from client device 112. In an embodiment, the sampling rate indicates what percentage of data values to select. For example, sampling program 104 may receive as user input a sampling rate of 0.33, in which case sampling program 104 selects 33% of data values of the starting table. In an embodiment, sampling program 104 selects data values from each of the previously determined groups of data values in proportion to the size of each group.

In some embodiments, sampling program 104 samples data values in approximate proportion to the sampling rate, or as close to the sampling rate as is possible. For example, a sampling rate of 50% is unachievable for an odd number of data values, in which case sampling program 104 may select data values in as close of a proportion to the sampling rate as is possible.

In some embodiments, sampling program 104 selects at least one data value from each group, which, in some cases, may result in sampling program 104 selecting a proportion of data values exceeding the sampling rate. For example, if a database has 500 data values in a starting table in 100 groups, selecting one data value from each group results in a minimum proportion of 20%, which may exceed a sampling rate (e.g., a sampling rate of 0.15). Alternatively, sampling program 104 may select no data values from a group if doing so would cause the number of selected data values relative to the number of data values of the starting table to exceed the sampling rate.

In step 314, sampling program 104 populates a first table of the sample with the data values selected in step 312, along with any primary keys and/or foreign keys corresponding to the selected data values.

In step 316, sampling program 104 populates the remainder of the tables of the sample according to the relational constraints of the data values of the sample starting table. In an embodiment, the proportion of the size of the sample relative to the size of the database is equal to the sampling rate.

FIG. 4 depicts a block diagram of components of computer system 102 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computer system 102 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Sampling program 104 and RDT 108 are stored in persistent storage 408 for execution and/or access by one or more of the respective computer processor(s) 404 via one or more memories of memory 406. In this embodiment, persistent storage 408 includes a magnetic hard disk drive. Alternatively, or in addition to a magnetic hard disk drive, persistent storage 408 can include a solid-state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including client device 112. In these examples, communications unit 410 includes one or more network interface cards. Communications unit 410 may provide communications through the use of either or both physical and wireless communications links. Sampling program 104 and/or RDT 108 may be downloaded to persistent storage 408 through communications unit 410.

I/O interface(s) 412 allows for input and output of data with other devices that may be connected to computer system 102. For example, I/O interface(s) 412 may provide a connection to external devices(s) 418 such as a keyboard, a keypad, a touch screen, and/or some other suitable input device. External devices(s) 418 can also include portable computer-readable storage media such as, for example, thumb drives, portable optical or magnetic disks, and memory cards. Software and data used to practice embodiments of the present invention, e.g., sampling program 104 and/or RDT 108, can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for representative sampling of a database, the method comprising:
determining, by a computing device, a first table included in a plurality of tables, wherein the plurality of tables are included in the database;
determining a dependency corresponding to the first table, wherein the dependency identifies a second table that is included in the plurality of tables;
determining a distribution corresponding to the dependency, wherein the distribution identifies a correlation corresponding to the first table and to the second table;
analyzing the correlation to determine a group of data values of the first table and the second table;
selecting a subset of data values from the group of data values; and
populating a sample with the subset.

2. The method of claim 1, wherein selecting the subset of data values comprises:
receiving a predetermined sampling rate; and
selecting the subset of data values from the group of data values in a proportion indicated by the predetermined sampling rate.

3. The method of claim 1, wherein the correlation identifies a data value included in the first table which corresponds to a data value included in the second table, and wherein the group of data values comprises a plurality of data values corresponding to a first correlation of a first distribution and a second correlation of a second distribution.

4. The method of claim 3, wherein the selected subset of data values includes at least one data value from the group of data values.

5. The method of claim 1, wherein determining the dependency corresponding to the first table comprises:
identifying a foreign key of the first table; and
identifying the second table, wherein the second table comprises a primary key that is referenced by the foreign key.

6. The method of claim 1, wherein the sample comprises a third table that includes data included in the plurality of tables.

7. The method of claim 1, wherein analyzing the distribution to determine the group of data values comprises:
receiving a predetermined importance value indicating a relative importance of a plurality of distributions, wherein the predetermined importance value identifies a first distribution and a second distribution of the plurality of distributions as important; and
analyzing each distribution of the plurality of distributions that is identified as important to determine the group of data values, wherein the group of data values comprises a plurality of data values corresponding to a correlation of each distribution identified as important by the importance value.

8. The method of claim 1, wherein determining the dependency comprises:
identifying a primary key of the first table; and
identifying the second table, wherein the second table comprises a foreign key, wherein the foreign key references the primary key.

9. A computer program product for representative sampling of a database, the computer program product comprising:
one or more computer-readable storage media and program instructions stored on the one or more computer-readable storage media, the program instructions comprising program instructions to:
determine a first table included in a plurality of tables, wherein the plurality of tables are included in the database;
determine a dependency corresponding to the first table, wherein the dependency identifies a second table that is included in the plurality of tables;
determine a distribution corresponding to the dependency, wherein the distribution identifies a correlation corresponding to the first table and to the second table;
analyze the correlation to determine a group of data values of the first table and the second table;
select a subset of data values from the group of data values; and
populate a sample with the subset.

10. The computer program product of claim 9, wherein the program instructions to select the subset of data values comprise program instructions to:
receive a predetermined sampling rate; and
select the subset of data values from the group of data values in a proportion indicated by the predetermined sampling rate.

11. The computer program product of claim 9, wherein the correlation identifies a data value included in the first table which corresponds to a data value included in the second table, and wherein the group of data values comprises a plurality of data values corresponding to a first correlation of a first distribution and a second correlation of a second distribution.

12. The computer program product of claim 11, wherein the selected subset of data values includes at least one data value from the group of data values.

13. The computer program product of claim 9, wherein the program instructions to determine the dependency corresponding to the first table comprise program instructions to:
identify a foreign key of the first table; and
identify the second table, wherein the second table comprises a primary key that is referenced by the foreign key.

14. The computer program product of claim 9, wherein the program instructions to analyze the distribution to determine the group of data values comprise program instructions to:
receive a predetermined importance value indicating a relative importance of a plurality of distributions, wherein the predetermined importance value identifies a first distribution and a second distribution of the plurality of distributions as important; and
analyze each distribution of the plurality of distributions that is identified as important to determine the group of data values, wherein the group of data values comprises a plurality of data values corresponding to a correlation of each distribution identified as important by the importance value.

15. A computer system for representative sampling of a database, the computer system comprising:
one or more computer processors;
one or more computer-readable storage media;
program instructions stored on the computer-readable storage media for execution by at least one of the one or more processors, the program instructions comprising program instructions to:
determine a first table included in a plurality of tables, wherein the plurality of tables are included in the database;
determine a dependency corresponding to the first table, wherein the dependency identifies a second table that is included in the plurality of tables;
determine a distribution corresponding to the dependency, wherein the distribution identifies a correlation corresponding to the first table and to the second table;
analyze the correlation to determine a group of data values of the first table and the second table;
select a subset of data values from the group of data values; and
populate a sample with the subset.

16. The computer system of claim 15, wherein the program instructions to select the subset of data values comprise program instructions to:
receive a predetermined sampling rate; and
select the subset of data values from the group of data values in a proportion indicated by the predetermined sampling rate.

17. The computer system of claim 15, wherein the correlation identifies a data value included in the first table which corresponds to a data value included in the second table, and wherein the group of data values comprises a plurality of data values corresponding to a first correlation of a first distribution and a second correlation of a second distribution.

18. The computer system of claim 17, wherein the selected subset of data values includes at least one data value from the group of data values.

19. The computer system of claim 15, wherein the program instructions to determine the dependency corresponding to the first table comprise program instructions to:
identify a foreign key of the first table; and
identify the second table, wherein the second table comprises a primary key that is referenced by the foreign key.

20. The computer system of claim 15, wherein the program instructions to analyze the distribution to determine the group of data values comprise program instructions to:
receive a predetermined importance value indicating a relative importance of a plurality of distributions, wherein the predetermined importance value identifies a first distribution and a second distribution of the plurality of distributions as important; and
analyze each distribution of the plurality of distributions that is identified as important to determine the group of data values, wherein the group of data values comprises a plurality of data values corresponding to a correlation of each distribution identified as important by the importance value.
